(19) United States
(12) Patent Application Publication
(10) Pub. No.: US 2019/0318592 A1
(43) Pub. Date: Oct. 17, 2019

(54) MULTIFUNCTIONAL EMERGENCY LIGHT

(71) Applicant: Gibong Kim, Pyeongtaek-si (KR)

(72) Inventor: Gibong Kim, Pyeongtaek-si (KR)

(21) Appl. No.: 16/454,652

(22) Filed: Jun. 27, 2019

Related U.S. Application Data
(63) Continuation of application No. PCT/KR2018/012285, filed on Oct. 17, 2018.

(30) Foreign Application Priority Data
Dec. 22, 2017 (KR) 10-2017-0178876

(51) Int. Cl. G08B 7/06; G08B 21/10; H04W 4/029; G08B 21/18; G08B 17/10; H04N 7/18

(52) U.S. Cl. CPC G08B 7/066; G08B 21/10; H04N 7/183; G08B 21/182; G08B 17/10; H04W 4/029

(57) ABSTRACT

A multifunctional emergency light includes a speaker for outputting an alarm in an emergency situation, a display panel for displaying an alarm in an emergency situation, and an earthquake detector.

### CROSS-REFERENCE TO RELATED APPLICATIONS

This application is a continuation application of International Application No. PCT/KR2018/012285 filed on Oct. 17, 2018, which claims priority to Korean Patent Application No. 10-2017-0178876 filed on Dec. 22, 2017, which applications are incorporated herein by reference.

### TECHNICAL FIELD

The present invention relates to a multifunctional emergency light capable of being used for multi purposes in case of an earthquake or a fire.

### RELATED ART

Generally, an emergency light is fixed on a wall of an emergency exit at a stairway in commercial buildings, hospitals or industrial sites, and when the building is out of power, the emergency light is automatically turned on to inform the exit of the emergency exit.

These emergency lights are turned on during a power failure and are a wall mount type that helps the user to find a way or a necessary item, and since most of the emergency lights are large in size and require a separate installation space, it is not easy to be installed and used in home and small-scale accommodations with limited spaces. Therefore, when a sudden power failure occurs in a general household, there is a problem in that various incidents arise in the course of finding and illuminating the candle in a dark room or nearly finding and lighting on a lantern provided.

In this aspect, there is disclosed a portable emergency light in which when a power failure occurs, a main body including a circuit and a lamp that may be automatically turned on by detecting the power failure is put on a charger cradle so that a battery is charged in a fully charged state, and a lamp is automatically turned on when a power failure occurs to act as an emergency light and the main body is detached from the charger cradle to be used as a lantern.

However, in the case of such a portable emergency light, it is disadvantageous not to be used as a fixed type, a separate charging cradle is required, and it is inconvenient that a space for placing the charging cradle is required.

Further, since the charging cradle and the main body form a set, there are problems in that when a terminal of the charging cradle and a terminal of the main body are in bad contact with each other due to abrasion or the like, the power is not supplied so that the light may not play a role as an emergency light, and the charging itself is not performed so that the light may not play a role as a lantern.

In order to improve these problems, the present applicant filed and received a patent registration (Korean Patent Registration No. 10-1327949) for an emergency light which is easily installed anywhere in a fixed way, or simply inserted into a wall outlet to play a role as an emergency light and is directly portable by a user to be used as a lantern in an emergency.

However, these existing emergency lights may only serve as emergency lights and may not provide other functions not to satisfy user convenience.

For example, when a power failure occurs due to an earthquake, the user directly carries the emergency light to use the emergency light as a lantern, but there is a problem that the user may not grasp information about the earthquake.

Similarly, when a power failure occurs due to a fire alarm, the user directly carries the emergency light to use the emergency light as a lantern, but there is a problem that the user may not determine information about the fire alarm and can not make a rescue request by informing the user's current location to the outside.

### SUMMARY

An object of the present invention is to provide a multifunctional emergency light capable of being used for multi purposes in case of an earthquake or a fire.

An exemplary embodiment of the present invention provides a multifunctional emergency light including a main body which includes a battery unit storing the power when the power is applied, a lighting unit lighting on or off in accordance with the power supply from the battery unit, and a control circuit unit lighting on the lighting unit by applying the power of the battery to the lighting unit by sensing a power failure, the multifunctional emergency light comprising: a speaker for outputting an alarm in an emergency situation; a display panel for displaying an alarm in an emergency situation; and an earthquake detector which includes an earthquake sensor to detect the earthquake and measure an earthquake vibration value, in which the control circuit unit includes an input power supply unit for receiving external DC power through the DC adapter and charging the battery unit, a switch unit for interrupting the power of the battery unit applied to the lighting unit, and a control unit for controlling an operation of the switch unit by detecting whether or not the input power of the input power supply unit is supplied, and control unit outputs the earthquake vibration value through the speaker and the display panel together with an earthquake alarm when the earthquake is detected together with the occurrence of a power failure.

The multifunctional emergency light may further include a fire detector for detecting a fire through the detection of a flame or smoke and measuring a fire detection value, in which the control unit may output the fire detection value through the speaker and the display panel together with a fire alarm when the fire is detected together with the occurrence of the power failure.

The multifunctional emergency light may further include an FM radio capable of listening to FM broadcasts, in which the control unit may drive the FM radio to output a disaster guidance broadcast, when the earthquake is detected together with the occurrence of the power failure, or the fire is detected together with the occurrence of the power failure.

The multifunctional emergency light may further include a location information determiner for determining location information; a mobile communication device for communicating with an external mobile communication network; and a motion detector including a motion detection sensor and measuring a detection value of a motion, in which the control unit may transmit the location information to a predetermined external mobile phone or a rescue center server to request a rescue, when the earthquake is detected together with the occurrence of the power failure, or the fire is detected together with the occurrence of the power failure.

The control unit may transmit the location information to the predetermined external mobile phone or the rescue center server to request the rescue, only when the earthquake vibration value exceeds a predetermined threshold vibration value or the fire detection value exceeds a predetermined threshold fire detection value.

The multifunctional emergency light may further include a camera which photographs the surroundings and creates surrounding images, in which the control unit may transmit the location information and surrounding images to the external mobile phone or the rescue center server, when the threshold vibration value is exceeded or the threshold fire detection value is exceeded.

The control unit may display disaster guidance information received from the external mobile phone or the rescue center server on the display panel.

According to the exemplary embodiment of the present invention, an earthquake detector, a fire detector, an FM radio, and the like are provided to cope with emergency situations.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an externally perspective view of a multifunctional emergency light according to an exemplary embodiment of the present invention;

FIG. 2 is a block view of a multifunctional emergency light according to an exemplary embodiment of the present invention;

FIG. 3 is a diagram illustrating switching of a control circuit unit in the case of no power failure according to the exemplary embodiment of the present invention;

FIG. 4 is a diagram illustrating switching of a control circuit unit in the case of a power failure according to the exemplary embodiment of the present invention;

FIG. 5 is a diagram illustrating a multifunctional emergency light that transmits location information to the outside according to the exemplary embodiment of the present invention;

FIG. 6 is a diagram illustrating a multifunctional emergency light that transmits location information and surrounding images to the outside according to the exemplary embodiment of the present invention; and

FIG. 7 is a diagram illustrating receiving and displaying disaster guidance information received from the outside according to the exemplary embodiment of the present invention.

### DETAILED DESCRIPTION

Advantages and features of the present invention, and methods for accomplishing the same will be more clearly understood from exemplary embodiments described in detail below with reference to the accompanying drawings. However, the present invention is not limited to the following exemplary embodiments but may be implemented in various different forms. The exemplary embodiments are provided only to make description of the present invention complete and to fully provide the scope of the present invention to a person having ordinary skill in the art to which the present invention pertains with the category of the invention, and the present invention will be defined by the appended claims. In the following description of the present invention, a detailed description of known arts related thereto will be omitted when it is determined to make the subject matter of the present invention rather unclear.

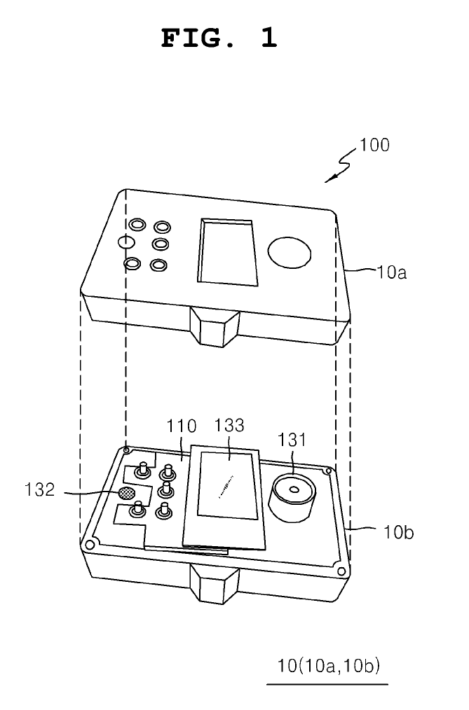

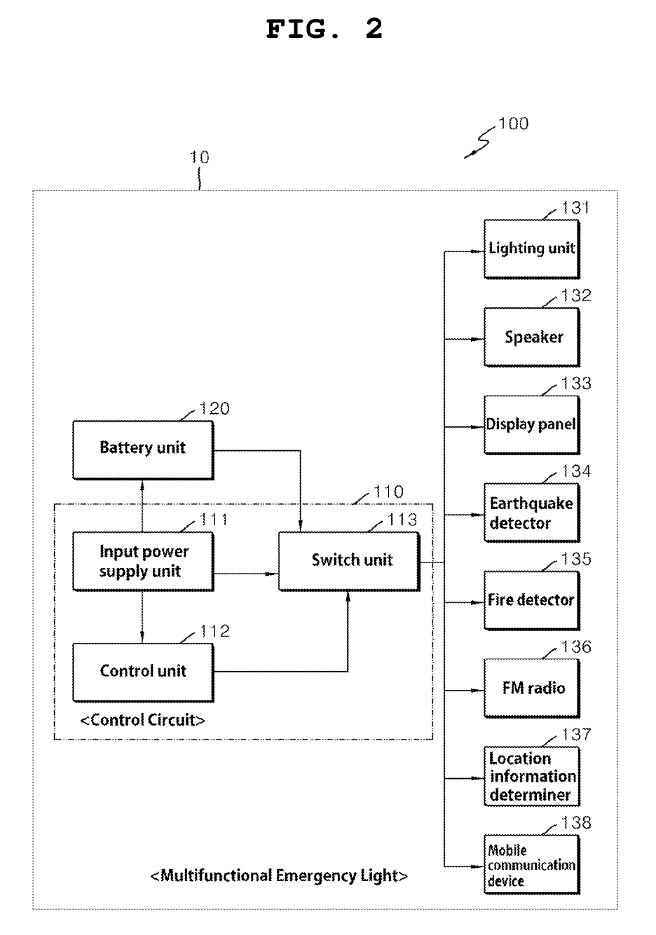

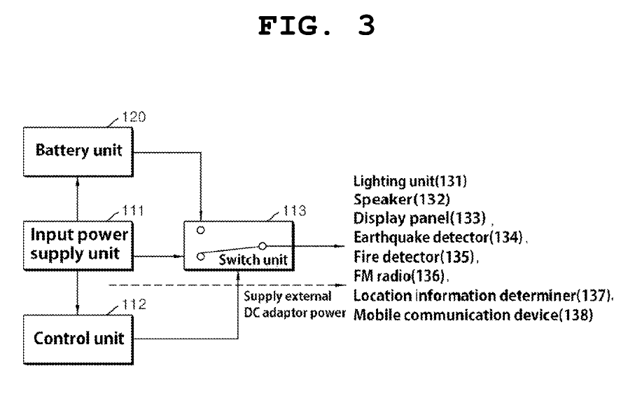

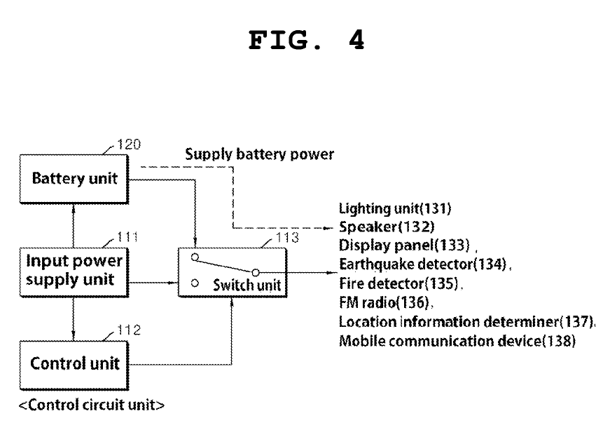

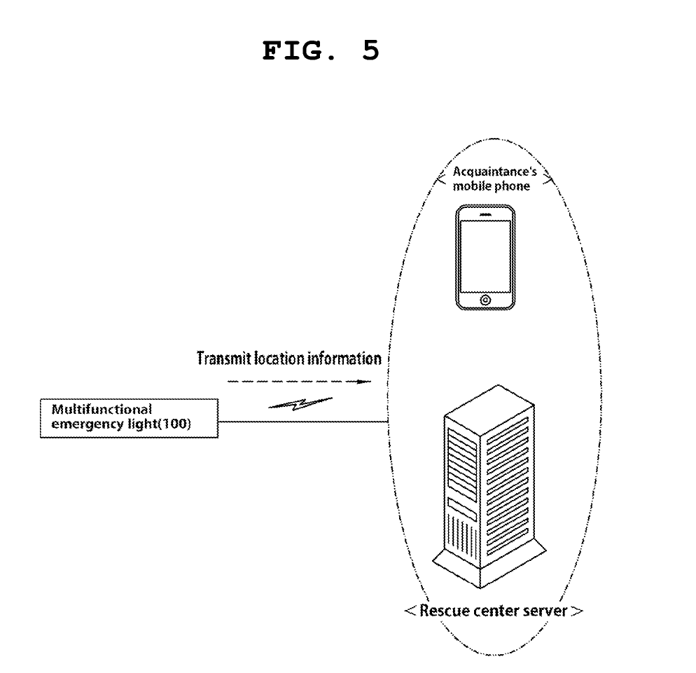

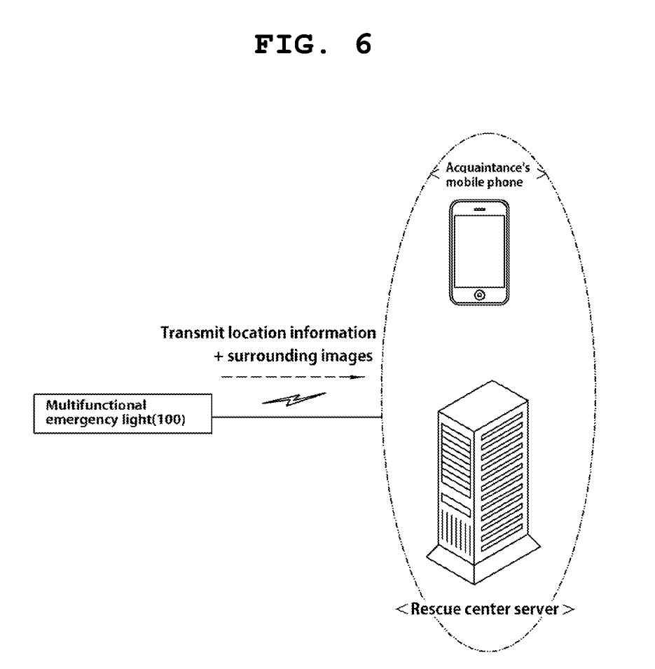

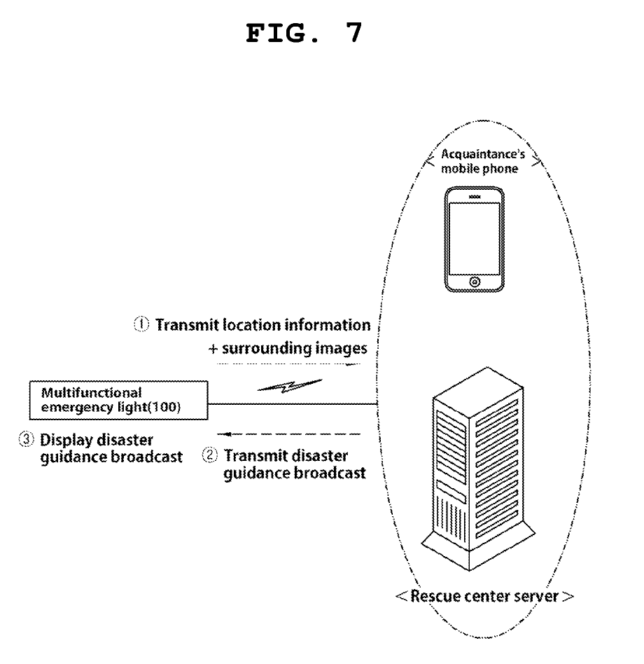

FIG. 1 is an externally perspective view of a multifunctional emergency light according to an exemplary embodiment of the present invention, FIG. 2 is a block view of a multifunctional emergency light according to an exemplary embodiment of the present invention, FIG. 3 is a diagram illustrating switching of a control circuit unit in the case of no power failure according to the exemplary embodiment of the present invention, FIG. 4 is a diagram illustrating switching of a control circuit unit in the case of a power failure according to the exemplary embodiment of the present invention, FIG. 5 is a diagram illustrating a multifunctional emergency light that transmits location information to the outside according to the exemplary embodiment of the present invention, FIG. 6 is a diagram illustrating a multifunctional emergency light that transmits location information and surrounding images to the outside according to the exemplary embodiment of the present invention, and FIG. 7 is a diagram illustrating receiving and displaying disaster guidance information received from the outside according to the exemplary embodiment of the present invention.

As illustrated in FIG. 1, a multifunctional emergency light 100 of the present invention includes a main body 10 and the main body 10 includes a lighting unit 131, a speaker 132, a display panel 133, a control circuit unit 110, and the like.

In addition, the multifunctional emergency light 100 of the present invention may be easily installed even at any place or inserted into an outlet provided on a wall surface to be used as an emergency light, and may be held by hand to perform a lantern function.

The multifunctional emergency light 100 of the present invention includes a separate DC adaptor and may receive power through the DC adaptor. External power input through the DC adapter charges a battery and power is supplied to the lighting unit 131, the speaker 132, the display panel 133, and the control circuit unit 110. In the following description, the multifunctional emergency light 100 receiving DC power through the DC adapter will be described as an example.

Further, in addition to the example of receiving the power through the DC adapter, as anther exemplary embodiment of the present invention, the multifunctional emergency light 100 may include an external power line fixing unit (not illustrated), a plug (not illustrated), and a main body 10 fixing piece (not illustrated) which are inside the main body 10, as disclosed in Korean Patent Registration No. 10-1327949.

The external power line fixing unit (not illustrated) is configured by an operating handle part (not illustrated) in which an external power line through-hole (not illustrated) into which the external power line is inserted is formed in the middle so as to easily fix the external power line in an one-touch way, a contact terminal (not illustrated) is fixed to the external power line through-hole (not illustrated), and one end is in contact with a compressed coil spring (not illustrated) to exhibit repulsive force at all times, and a body part (not illustrated) in which an external power line accommodating groove (not illustrated) is formed in the middle to pass through the external power line through-hole (not illustrated) of the operating handle part (not illustrated) and the operating handle part (not illustrated) is slidably fixed in a horizontal direction.

Further, at the lower center of the main body 10, the plug (not illustrated) is formed at a location separated from the external power line fixing unit (not illustrated) of the main body 10 to be inserted into an external outlet 2 for applying the power, and such a plug (not illustrated) is also foldably configured to be drawn out from the bottom of the main body 10 only when the plug (not illustrated) is used.

Hereinafter, since the external power line fixing unit (not illustrated), the plug (not illustrated), and the main body 10 fixing piece (not illustrated) are described in detail in Korean Patent Registration No. 10-1327949 filed and registered by the present applicant, the detailed description will be omitted.

The multifunctional emergency light 100 of the present invention illustrated in FIG. 2 may include a speaker 132, a display panel 133, an earthquake detector 134, a fire detector 135, an FM radio 136, a location information determiner 137, and a mobile communication device 138, in addition to the battery unit 120 storing the power when the power is applied, the lighting unit 132 lighting on or off in accordance with the power supply from the battery unit 120, and the control circuit unit 110 lighting on the lighting unit 131 by applying the power of the battery unit 120 to the lighting unit 131 by detecting a power failure when the power failure occurs.

The main body 10 has a rectangular parallelepiped shape composed of a cover body 10a and a main body 10b, and the lighting unit 131 such as an illumination lamp, the speaker 132, and the display panel 133, and the like are disposed inside the cover.

The battery unit 120 supplies the battery power to the lighting unit 131, the speaker 132, the display panel 133, the earthquake detector 134, the fire detector 135, the FM radio 136, the location information determiner 137, and the mobile communication device 138, and when a power failure occurs in which the power from the outside is disconnected, the battery power is supplied to the lighting unit 131, the speaker 132, the display panel 133, the earthquake detector 134, the fire detector 135, the FM radio 136, the location information determiner 137, and the mobile communication device 138.

The speaker 132 is a module for outputting an alarm in an emergency situation. In addition, a voice amplifier may be additionally provided.

The display panel 133 is a module for displaying an alarm in an emergency situation. The display panel 133 may be implemented as an LCD, an LED, or the like, but may be implemented as a touch screen panel capable of simultaneously performing input and display operations.

The earthquake detector 134 includes an earthquake sensor to detect the earthquake and measure an earthquake vibration value. The earthquake detector 134 detects displacements of X, Y, and Z axes by using a three-axial acceleration sensor or the like to measure the earthquake and the earthquake vibration value.

The control circuit unit 110 includes an input power supply unit 111 for receiving external DC power through the DC adapter and charging the battery unit 120, a switch unit 113 for interrupting the power of the battery unit 120 applied to the lighting unit 131, and a control unit 112 for controlling an operation of the switch unit 113 by detecting whether or not the input power of the input power supply unit 111 is supplied.

In a normal situation other than the power failure, as illustrated in FIG. 3, the control circuit unit 110 controls the operation of the switch unit 113 so that the external DC power is normally supplied to the lighting unit 131, the speaker 132, the display panel 133, the earthquake detector 134, the fire detector 135, the FM radio 136, the location information determiner 137, and the mobile communication device 138 through the input power supply unit 111.

On the other hand, when the power failure occurs due to an earthquake or a fire, as illustrated in FIG. 4, the control circuit unit 110 controls the operation of the switch unit 113 so that the battery power is supplied to the lighting unit 131, the speaker 132, the display panel 133, the earthquake detector 134, the fire detector 135, the FM radio 136, the location information determiner 137, and the mobile communication device 138.

In addition, when an earthquake is detected together with the occurrence of a power failure, the control unit 112 outputs an earthquake vibration value through the speaker 132 and the display panel 133 together with an earthquake alarm. Accordingly, when the power failure occurs due to an earthquake, the earthquake occurrence and the earthquake vibration value are output from the speaker 132 and the display panel 133 together with the light emission of the lighting unit 131, so that the user may detect the earthquake occurrence and quickly escape.

Furthermore, the multifunctional emergency light 100 of the present invention may include a fire detector 135 for detecting a fire through the detection of a flame or smoke and measuring a fire detection value. Here, the fire detection value may correspond to a smoke amount, a flame size, a poison gas amount, and the like.

Accordingly, when the fire is detected together with the occurrence of the power failure, the control unit 112 outputs a fire detection value through the speaker 132 and the display panel 133 together with a fire alarm. Accordingly, when the power failure occurs due to the fire, the fire occurrence and the fire detection value are output from the speaker 132 and the display panel 133 together with the light emission of the lighting unit 131, so that the user may detect the fire occurrence and quickly escape.

Further, the multifunctional emergency light 100 of the present invention may include an FM radio 136 capable of listening to FM broadcasts. Accordingly, when the earthquake is detected together with the occurrence of the power failure, or the fire is detected together with the occurrence of the power failure, the control unit 112 may drive the FM radio 136 to output a disaster guidance broadcast. Therefore, when the earthquake is detected together with the occurrence of the power failure, or the fire is detected together with the occurrence of the power failure, the disaster guidance broadcast is automatically output through the FM radio 136, thereby enabling the user to recognize the disaster situation in real time.

Furthermore, the multifunctional emergency light 100 of the present invention may include a location information determiner 137 for determining location information, a mobile communication device 138 for communicating with an external mobile communication network, and and a motion detector including a motion detection sensor and measuring a detection value of a motion.

Here, the location information determiner 137 may be GPS location information received from a GPS satellite, or may be information using location identification information of a mobile communication base station. In addition, the location information determiner 137 may set and register the location information from the user.

Further, the mobile communication device 138 is a module which performs a function of communicating with an external mobile phone or a rescue center server through a mobile communication network which communicates data using a wireless mobile communication network consisting of a base transceiver station (BTS), a mobile switching center (MSC), and a home location register (HLP). When performing mobile communication such as 3G and 4G, the mobile communication device 138 includes a RF transmitter which up-shifts and amplifies a frequency of a signal to be transmitted wirelessly and an RF receiver that amplifies a wireless signal to be received with low noise and down-shifts the frequency.

When the earthquake is detected together with the occurrence of the power failure, or the fire is detected together with the occurrence of the power failure, as illustrated in FIG. 5, the control unit 112 may transmit the location information in real time to a predetermined external mobile phone or a rescue center server to request a rescue. Therefore, when a user is locked in a building due to an earthquake or the like, the user's location is transmitted to an acquaintance's mobile phone or a rescue center server in real time, thereby enabling an efficient rescue.

However, it is unnecessary to request a rescue when a small earthquake or fire occurs, when requesting a rescue whenever an earthquake or a fire occurs. Accordingly, only when the earthquake vibration value exceeds a predetermined threshold vibration value or when the fire detection value exceeds a predetermined threshold fire detection value, the control unit 112 of the present invention transmits the location information to the predetermined external mobile phone or the rescue center server to request the rescue.

That is, only when an earthquake with a threshold vibration value enough to collapse the building occurs or a fire with a threshold fire detection value hard enough to escape occurs, the control unit 112 transmits the location information to the predetermined external mobile phone or the rescue center server to request the rescue.

For reference, here, the external mobile phone may correspond to smart phones, tablet PCs, personal digital assistants (PDAs), portable multimedia players (PMPs), navigations, and the like of the acquaintances. Of course, it is natural that the terminal to which the present invention is applicable is not limited to the above-described types, but may include all terminals capable of communicating with external devices.

Further, the rescue center server includes may correspond to a 119 center server, a national police agency center server, and the like, and may include a program module which has the same configuration as a typical web server with hardware, and is implemented in various types of languages such as C, C ++, Java, Visual Basic, and Visual C with software to perform various functions.

Meanwhile, the multifunctional emergency light 100 of the present invention may include a camera which photographs the surroundings and creates surrounding images.

Accordingly, when the threshold vibration value is exceeded or the threshold fire detection value is exceeded, as illustrated in FIG. 6, the control unit 112 transmits the location information and the surrounding images to the external mobile phone or the rescue center server.

When the building is collapsed and a person carrying the multifunctional emergency light 100 of the present invention is locked in the building, the control unit 112 transmits information on a locked location as an image to the external mobile phone or the rescue center server, thereby enabling an efficient rescue.

Further, when the disaster guidance information is received from the external mobile phone or the rescue center server, as illustrated in FIG. 7, the disaster guidance information received from the external mobile phone or the rescue center server is displayed on the display panel 133. Therefore, even if the person is locked in the building, it is possible to find an escape route, or to have mental stability by checking external disaster guidance information through the display panel 133 of the multifunctional emergency light 100.

The exemplary embodiments described in the description of the present invention are presented by selecting the most preferable exemplary embodiment in order to help the understanding of those skilled in the art among the various feasible examples. The technical idea of the present invention is not necessarily limited to or restricted to only this exemplary embodiment, and various changes, modifications, and other equivalent exemplary embodiments are possible without departing from the technical idea of the present invention.

What is claimed is:

1. A multifunctional emergency light including a main body which includes a battery unit storing the power when the power is applied, a lighting unit lighting on or off in accordance with the power supply from the battery unit, and a control circuit unit lighting on the lighting unit by applying the power of the battery to the lighting unit by detecting a power failure when the power failure occurs, the multifunctional emergency light comprising:
a speaker for outputting an alarm in an emergency situation;
a display panel for displaying an alarm in an emergency situation; and
an earthquake detector which includes an earthquake sensor to detect the earthquake and measure an earthquake vibration value,
wherein the control circuit unit includes an input power supply unit for receiving external DC power through the DC adapter and charging the battery unit, a switch unit for interrupting the power of the battery unit applied to the lighting unit, and a control unit for controlling an operation of the switch unit by detecting whether or not the input power of the input power supply unit is supplied, and
the control unit outputs the earthquake vibration value through the speaker and the display panel together with an earthquake alarm when the earthquake is detected together with the occurrence of a power failure.

2. The multifunctional emergency light of claim 1, further comprising:
a fire detector for detecting a fire through the detection of a flame or smoke and measuring a fire detection value,
wherein the control unit outputs the fire detection value through the speaker and the display panel together with a fire alarm when the fire is detected together with the occurrence of the power failure.

3. The multifunctional emergency light of claim 2, further comprising:
an FM radio capable of listening to FM broadcasts,
wherein the control unit drives the FM radio to output a disaster guidance broadcast, when the earthquake is detected together with the occurrence of the power failure, or the fire is detected together with the occurrence of the power failure.

4. The multifunctional emergency light of claim 2, further comprising:
a location information determiner for determining location information;
a mobile communication device for communicating with an external mobile communication network; and
and a motion detector including a motion detection sensor and measuring a detection value of a motion
wherein the control unit transmits the location information to a predetermined external mobile phone or a rescue center server to request a rescue, when the earthquake is detected together with the occurrence of the power failure, or the fire is detected together with the occurrence of the power failure.

5. The multifunctional emergency light of claim 4, wherein the control unit transmits the location information to the predetermined external mobile phone or the rescue center server to request the rescue, only when the earthquake vibration value exceeds a predetermined threshold vibration value or the fire detection value exceeds a predetermined threshold fire detection value.

6. The multifunctional emergency light of claim 4, further comprising:
a camera which photographs the surroundings and creates surrounding images,
wherein the control unit transmits the location information and surrounding images to the external mobile phone or the rescue center server, when the threshold vibration value is exceeded or the threshold fire detection value is exceeded.

7. The multifunctional emergency light of claim 4, wherein the control unit displays disaster guidance information received from the external mobile phone or the rescue center server on the display panel.
